(19) United States
(12) Patent Application Publication
(10) Pub. No.: US 2016/0286100 A1
(43) Pub. Date: Sep. 29, 2016

(54) SUBMINIATURE IMAGE INPUT DEVICE HAVING DOUBLE COUPLING STRUCTURE

(71) Applicant: SPS Inc., Daejeon (KR)

(72) Inventor: Hyun-Jun Kim, Daejeon (KR)

(21) Appl. No.: 14/938,104

(22) Filed: Nov. 11, 2015

(30) Foreign Application Priority Data
Mar. 27, 2015 (KR) 10-2015-0043440
Jun. 2, 2015 (KR) 10-2015-0077724

(51) Int. Cl. H04N 5/225; H02J 7/00

(52) U.S. Cl. CPC H04N 5/2252; H02J 7/0036; H02J 7/0052

(57) ABSTRACT

An image input device, such as a subminiature image input device, having a double coupling structure is disclosed. The image input device is modularized to be portable and have various functions such as power charging, wired-wireless data communication, and data storage. Further, the image input device can be easily and selectively coupled to other external devices to extend the functionality thereof. The image input device includes a main module and a sub-module. The main module includes a camera unit, configured to capture an image, and a pin terminal unit, which comes into contact with a pattern electrode and generates a first operation signal to operate the camera unit. The sub-module includes the pattern electrode, which comes into contact with the pin terminal unit and generates the first operation signal, and a power signal to activate the camera unit.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

1. Field

The present disclosure generally relates to image input devices, and more particularly to image input devices having a plurality of modules that are configured to be electrically, physically and removably coupled to each other.

2. Description of the Related Art

Recently, as the diversity of image input devices for inputting peripheral images increases, a variety of image input devices are being introduced and used in a variety of fields.

For example, black boxes for vehicles capture all images in the moving path of a vehicle that are visible from the vehicle. CCTVs are installed for security in buildings and alongside roads so as to monitor the conditions at the peripheries thereof. Home cameras and CCTVs are used to promote the safety of pets and children. Such image input devices have been appropriately used in various fields according to the purpose of use.

As such, as various image input devices are used according to the purpose of use, the functions and sizes thereof are diverse. Given this, users often purchase different image input devices for use in respective fields.

Although it may sometimes be preferable for image input devices to be affixed in one place to capture images, it may in other times be preferable for image input devices to be removably attached at a desired position whenever they are used. In the case of comparatively large image input devices, it is not easy to install an image input device at a desired position whenever needed.

For example, as the number of bicycle users has recently significantly increased in the interests of health, environmental conservation, and reduction in transportation expenses, the number of traffic accidents involving bicycles has also increased.

When a traffic accident related to a bicycle occurs, the bicycle rider may be severely injured, unlike the occupant of the vehicle. However, even if the bicycle user is not at fault in the accident, there is no way to prove it other than using a black box attached to the vehicle or a CCTV installed nearby alongside the road. If the traffic accident occurs in an unrecorded area, the bicycle rider may not easily obtain evidential data, despite suffering a serious loss.

Nowadays black boxes are widely used in automobiles as well as airplanes and ships. Black boxes are also used in for bicycles, which are a kind of vehicle.

However, unlike vehicles, bicycles have no separate power supply, and it is difficult to install a typical black box on a bicycle. Furthermore, given the size of a bicycle, it is not easy to mount a comparatively voluminous black box to the bicycle. In addition, because bicycles are used outdoors, there is a risk of such a comparatively expensive black box being stolen.

Therefore, an image input device that can be easily mounted to or removed from a bicycle depending on whether the bicycle is in use, and that is small relative to the bicycle, is desirable.

In other words, an image input device that can be used when needed, can be easily removed to prevent it from being stolen, and can be used in various fields is desirable.

Related conventional techniques were proposed in Korean Patent Unexamined Publication No. 2012-127021 (date: Nov. 21, 2012, entitled: SUBMINIATURE CAMERA MODULE) and Korean Utility Model Registration No. 0474788 (date: Oct. 7, 2014, entitled: APPARATUS FOR ADJUSTING BLACKBOX INCLUDING BATTERY PACK).

### SUMMARY

Accordingly, in view of the above problems occurring in the prior art, one object of the present disclosure is to provide an image input device, e.g., a subminiature image input device, having a double coupling structure which can be used as a portable image input device.

Another object of the present disclosure is to provide an image input device, e.g., a subminiature image input device, e having a double coupling structure in which the function and volume of the main module are minimized and a sub-module, which provides additional functions, selectively extends the function of the main module.

A further object of the present disclosure is to provide an image input device, e.g., a subminiature image input device, having a double coupling structure which is configured such that the main module is operated without using a separate switch whenever the sub-module is coupled to the main module.

The technical object of the present disclosure is not limited to the above-mentioned objects.

According to various embodiments, a subminiature image input device has a double coupling structure which is modularized to be portable and have various functions such as power charging, wired-wireless data communication, and data storage, and which can be easily and selectively coupled to other external devices to extend the functionality thereof.

In order to accomplish the above object, the present disclosure describes an image input device, e.g., a subminiature image input device, having a double coupling structure, including: a main module comprising a camera unit configured to capture an image, and a pin terminal unit coming into contact with a pattern electrode and generating a first operation signal to operate the camera unit; and a sub-module comprising the pattern electrode coming into contact with the pin terminal unit and generating the first operation signal and a power signal to activate the camera unit.

The main module may further include a first processing unit controlling power of the camera unit and image information obtained by the camera unit.

The pin terminal unit may include at least one of a charging terminal, a data communication terminal, and a signal terminal.

The main module may further include a coupling detection unit generating a second operation signal to operate the camera unit from an outside, and the sub-module further comprises a detection means configured to be coupled to the coupling detection unit so that the second operation signal can be generated. The first processing unit may receive the first operation signal, generated by bringing the pin terminal unit into contact with the pattern electrode, and control the camera unit, or receive the second operation signal, generated by the coupling of the coupling detection unit to the detection means, and control the camera unit.

The first processing unit may receive both the first operation signal and the second operation signal and control the camera unit.

The first processing unit may include: a memory unit storing image information obtained by the camera unit; a charging unit configured to be charged through the pin terminal unit; and a control unit receiving at least one of the first operation signal, generated when the pin terminal unit is coupled to the pattern electrode, and the second operation signal, generated when the coupling detection unit is coupled to the detection means, and then controlling the camera unit.

The main module and the sub-module may further include respective magnets generating magnetic force. The magnets may be disposed such that opposite poles face each other.

The coupling detection unit may include, as a detection means, any one of a contact signal terminal, a magnetic sensor, a proximity sensor, and a radio recognition sensor.

The pattern electrode may be configured to have a conductive plate shape corresponding to a pin terminal that can generate the first operation signal.

The pattern electrode may be patterned to have a concentric circle shape, or be patterned to have a pin shape at a position corresponding to the pin terminal unit.

The sub-module may further include a second processing unit, including at least one of: a location tracking unit configured to receive location information; a memory unit storing the location information and backup data of the main module; a wired-wireless communication means for communicating with an external communication means in a wired or wireless manner; and a charging unit providing power to the main module.

The sub-module may further include a mounting part to which the main module is mounted such that the main module is prevented from being removed from the sub-module.

The sub-module may further include an installation means for fastening the sub-module at a desired position.

The sub-module may further include a connector configured to be connected to an external auxiliary device for extension of functionality.

The sub-module may be configured such that a pin terminal unit is formed on a surface of the sub-module other than a surface thereof on which the pattern electrode is formed.

When the main module is coupled to the sub-module and connected, by the connector of the sub-module, to a display means, which is the auxiliary device, image information of the main module may be output to the display means.

The display means may include any one selected from among a smartphone, a computer, and an imaging device.

As described above, an image input device, e.g., a subminiature image input device, having a double coupling structure according to the present invention is easily portable and rechargeable and can be easily mounted at any position so as to record desired images.

For example, the image input device may be mounted to a transportation means such as a bicycle to function as a black box.

Furthermore, in various embodiments disclosed herein, a main module has a basic camera function, and a sub-module has other extended functions. Thus, the size of the main module can be reduced.

The sub-module is waterproof and dustproof because it uses a pattern electrode, and thus has no holes or openings. Therefore, the disclosed embodiments are appropriate for use with bicycles, which are mainly used outdoors.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating an image input device having a double coupling structure according to embodiments;

FIG. 2 is a functional block diagram showing a main module of the image input device according to embodiments;

FIG. 3 is a functional block diagram showing a sub-module of the image input device according to embodiments;

FIGS. 4A through 4C are views showing examples of a pattern electrode of the image input device according to embodiments;

FIGS. 5A through 5D are views showing examples of configuration of the main module and the sub-module according to embodiments;

FIGS. 6A and 6B are views illustrating a connector-type sub-module according to embodiments;

FIGS. 7 through 9 are views showing examples of the image input device coupled to a display means, which is a kind of auxiliary device;

FIG. 10 is a view showing a bicycle on which the image input device according to embodiments is installed;

FIG. 11 is a view showing a sub-module having a clip-type installation means according to an embodiment; and

FIG. 12 is a view showing a battery-type sub-module of the image input device according to an embodiment, which is coupled to both a power supply means and the main module.

### DETAILED DESCRIPTION

Hereinafter, an exemplary embodiment of the present invention will be described in detail with reference to the attached drawings. Reference now is made to the drawings, in which the same reference numerals are used throughout the different drawings to designate the same or similar components. In the following description, redundant descriptions and detailed descriptions of known functions and elements that may unnecessarily make the gist of the present invention obscure will be omitted.

FIGS. 1 through 12 illustrate the configuration and operation of an image input device having a double coupling structure according to exemplary embodiments, and a detailed description thereof is as follows. The image input device may be a subminiature image input device, which can provide various advantages, as disclosed herein.

As shown in FIG. 1, the image input device according to exemplary embodiments includes a main module 100 and a sub-module 200.

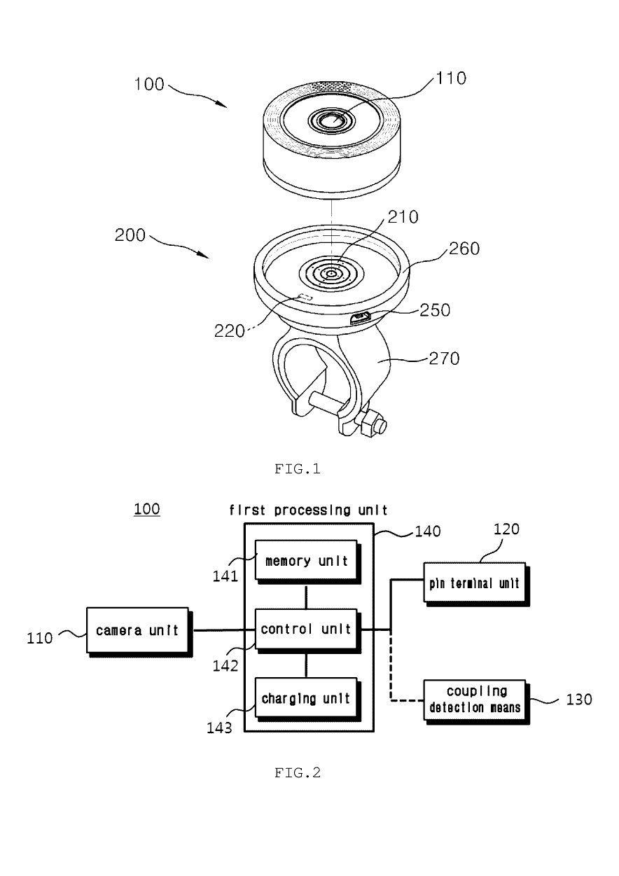

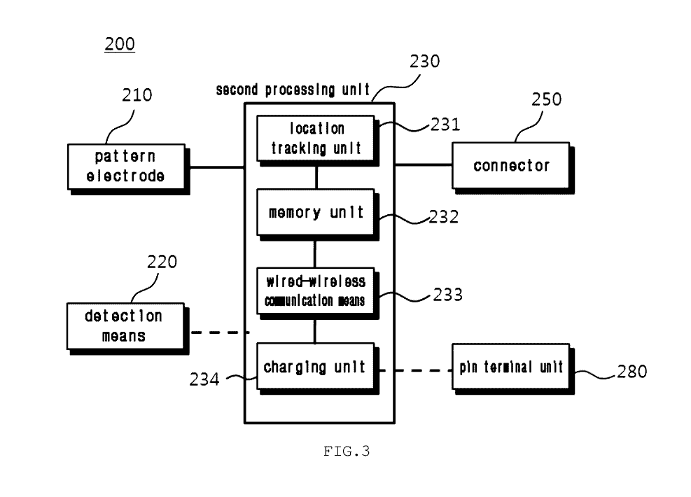

As shown in FIGS. 1 and 2, the main module 100 includes a camera unit 110, a pin terminal unit 120, a coupling detection unit 130, a first processing unit 140, and a magnet 150. As shown in FIGS. 1 and 3, the sub-module 200 includes a pattern electrode 210, a detection means 220, a second processing unit 230, a connector 250, a magnet 240, a mounting part 260, an installation means 270, and a pin terminal unit 280.

The camera unit 110 of the main module 100 captures video images from the outside. The operation of the camera unit 110 will be explained later herein.

The camera unit 110 preferably does not include a separate shutter, because the camera unit 110 mainly captures video rather than still photographs.

The pin terminal unit 120 generates a first operation signal to operate the camera unit 110. The first operation signal is generated when the pin terminal unit 120 is connected to the pattern electrode 210 of the sub-module 200.

Furthermore, the pin terminal unit 120 includes one or more of a charging terminal, a data communication terminal, and a signal terminal.

The coupling detection unit 130 is connected to the detection means 220 of the sub-module 200 and generates a second operation signal to operate the camera unit 110. The coupling detection unit 130 may comprise any one among a contact signal terminal, a magnetic sensor, a proximity sensor, and a radio recognition sensor.

The first processing unit 140 includes a memory unit 141, a control unit 142, and a charging unit 143 so as to control the power of the camera unit 110 and image information obtained by the camera unit 110.

The memory unit 141 stores image information obtained by the camera unit 110. The charging unit 143 provides, via the pin terminal unit 120, power to operate the camera unit 110. The control unit 142 controls the operation of the camera unit 110 after receiving at least one of the first operation signal, generated when the pin terminal unit 120 is coupled to the pattern electrode 210 of the sub-module 200, and the second operation signal, generated when the coupling detection unit 130 is coupled to the detection means 220 of the sub-module 200.

For example, in the case where the main module 100 includes only the pin terminal unit 120, without having the coupling detection unit 130, the first processing unit 140 may use the first operation signal to control the camera unit 110. In the case where the main module 100 includes not only the pin terminal unit 120 but also the coupling detection unit 130, the first processing unit 140 may use the second operation signal to control the camera unit 110, or may use both the first operation signal and the second operation signal to control the camera unit 110.

As such, the kind of operation signal received may change depending on the configuration of the main module 100. With regard to controlling the camera unit 110 using the first processing unit 140, the main module 100 does not include a separate switch, so that any one or more of the coupling of the pin terminal unit 120 to the pattern electrode 210 and the coupling of the coupling detection unit 130 to the detection means 220 can substitute for a switch.

In some embodiments, without such coupling, the main module 100 cannot be operated alone.

The main module 100 may further include a display unit (not shown) which is configured such that when the camera unit 110 is operated by the first processing unit 140, a user can easily check whether the camera unit 110 is operating or not.

The magnet 150 is installed in the pin terminal unit 120 and is able to have various sizes and shapes. The magnet 150 functions both to guide the pin terminal unit 120 such that the pin terminal unit 120 is disposed at a position corresponding to the pattern electrode 210 of the sub-module 200 and to attach the pin terminal unit 120 to the pattern electrode 210. The operation of the magnet 150 will be explained in more detail in the description of the magnet 240 of the sub-module 200.

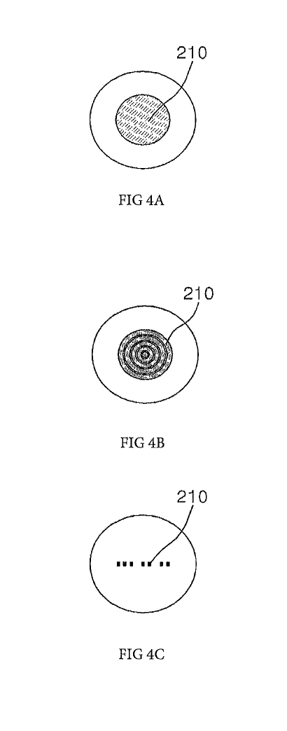

As shown in FIGS. 4A through 4C, the pattern electrode 210 of the sub-module 200 can have various shapes.

The pattern electrode 210 is formed at a position corresponding to the pin terminal unit 120 of the main module 100 by patterning in any one shape selected from among the conductive plate shape of FIG. 4A, the concentric circle shape of FIG. 4B, and the multi-pin shape of FIG. 4C. The pattern electrode 210 comes into contact with the pin terminal unit 120 of the main module 100 and thus generates the first operation signal.

Depending on the shape of the pattern electrode 210, some functions of the main module 100 may be restricted, although the camera unit 110 of the main module 100 can be operated regardless of the shape of the pattern electrode 210.

Preferably, the detection means 220 is disposed on the same side as the side on which the pattern electrode 210 is disposed. When the main module 100 comes into contact with the sub-module 200, the detection means 220 is coupled to the coupling detection unit 130, which is disposed on the same surface as that on which the pin terminal unit 120 is formed. The detection means 220 generates the second operation signal when it is coupled to the coupling detection unit 130.

The detection means 220 may comprise any one selected from among a contact signal terminal, a magnetic sensor, a proximity sensor, and a radio recognition sensor, which corresponds to the coupling detection unit 130.

The second processing unit 230 includes a location tracking unit 231, a memory unit 232, a wired-wireless communication means 233, and a charging unit 234.

The location tracking unit 231 receives information about the location of the sub-module 200, in other words, the location of the user, and uses it to conduct the tracking operation.

The location tracking unit 231 begins the tracking operation when the sub-module 200 is coupled to the main module 100, and stops the tracking operation when the sub-module 200 is separated from the main module 100.

The memory unit 232 backs up both the location information received from the location tracking unit 231 and the image information obtained from the main module 100 and stores them.

The memory unit 232 can store the location information and the image information after matching them with each other. Unless the user deletes the stored information, the memory unit 232 may continuously store information regardless of whether the sub-module 200 is coupled to or separated from the main module 100. Furthermore, the memory unit 232 may store fresh information while deleting the oldest information.

The wired-wireless communication means 233 communicates with a communication means of a separate auxiliary device in a wired or wireless manner, thus transmitting data thereto.

In other words, the wired-wireless communication means 233 is a means for transmitting image information stored in the memory unit 232 to the outside. In this way, the image information can be backed up.

The charging unit 234 can charge a charging unit 143 of the main module 100 so as to provide power to the main module 100.

The magnet 240 is disposed at a position corresponding to the magnet 150 provided in the main module 100 and functions to maintain the coupling of the sub-module 200 to the main module 100.

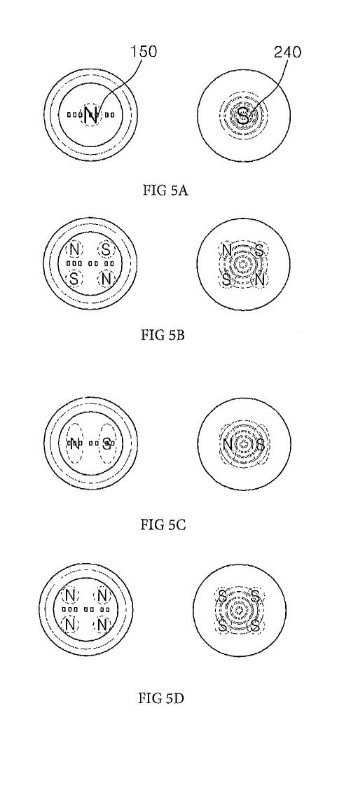

As shown in FIGS. 5A through 5D, each of the magnets 150 and 240 of the main module 100 and the sub-module 200 according to embodiments may comprise one through four magnets.

In these embodiments, although each magnet has been illustrated as comprising four or fewer for the sake of convenience or reducing production costs, more magnets may be used without causing functional problems.

As shown in FIGS. 5A and 5D, in some embodiments, each of the main module 100 and the sub-module 200 may have a single magnet 150, 240 or a plurality of magnets 150, 240 of the same polarity. Furthermore, the polarity of the magnet 150 of the main module 100 is opposite to that of the magnet 240 of the sub-module 200. In this case, when the main module 100 is coupled to the sub-module 200, the pin terminal unit 120 of the main module 100 can be easily attached to the pattern electrode 210 of the sub-module 200 regardless of the orientation of the main module 100 and the sub-module 200.

Furthermore, although an N-pole is illustrated in FIGS. 5A and 5D as being provided on the main module 100, this is only one example. In other words, any pole may be provided on the main module 100 or the sub-module 200, as long as opposite poles are respectively provided on the main module 100 and the sub-module 200.

Alternatively, as shown in FIGS. 5B and 5C, each of the main module 100 and the sub-module 200 may have both poles. Although the coupling of the sub-module 200 to the main module 100 in this configuration depends on the orientation of the main module 100 and the sub-module 200, the main module 100 and the sub-module 200 can be automatically attached to each other by magnetic force within a predetermined angular range, and the coupling force therebetween can be enhanced.

The connector 250 connects the main module 100 to an external auxiliary device using a cable c so that the function of the sub-module 200 can be extended.

The auxiliary device may comprise any one selected from among a communication means, a location information providing means, a storage means, a power supply means 20, and a display means 10. The display means 10 may comprise any one selected from among a smartphone, a computer, and an imaging device.

The auxiliary device is configured to extend the function of the disclosed embodiments but is not directly related to the image input device according to the embodiments. Therefore, a detailed description of the subsidiary device will be omitted.

When the connector 250 is connected to the storage means, which is a kind of auxiliary device, image information input from the camera unit 110 of the main module 100 can be stored in the external storage means. When the connector 250 is connected to the power supply means 20, which is a kind of auxiliary device, power is supplied to the charging unit 143 of the main module 100 to charge it.

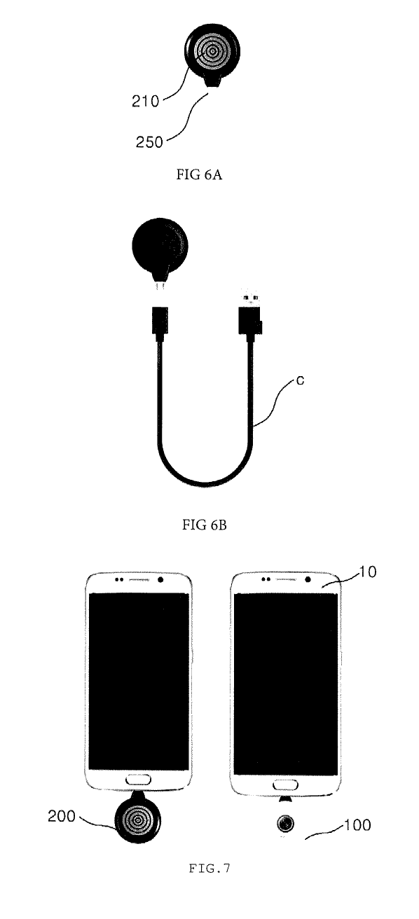

When the connector 250 is connected to the display means 10, which is a kind of auxiliary device, image information stored in the memory unit 141 of the main module 100 or the memory unit 232 of the sub-module 200 can be output to the display means 10. This operation will be explained in more detail in the description of FIGS. 6 through 8.

The connector 250 may have a female connection structure, as shown in FIG. 1, or a male connection structure, as shown in FIGS. 6A and 6B. As needed, the connector 250 may have any one selected from between the female connection structure and the male connection structure.

FIGS. 7 through 9 are views illustrating embodiments of the image input device coupled to a display means 10, which is a kind of auxiliary device. As shown in these drawings, the sub-module 200 is mounted to the display means 10 so that an image captured by the main module 100 can be output to the display means 10.

Here, the sub-module 200 can use wired or wireless communication to transmit the image captured by the main module 100 to the display means 10.

In an embodiment of a method of coupling the image input device to a smartphone, which is one of the display means 10, as shown in FIG. 7, the connector 250 of the sub-module 200 is coupled to the smartphone before the main module 100 is coupled to the sub-module 200 so that the image stored in the main module 100 can be output to the smartphone.

The sub-module 200 coupled to the main module 100 is mounted to the smartphone and thus functions as an OTG memory so that image information stored in the memory unit 141 of the main module 100 or the memory unit 232 of the sub-module 200 can be output to the smartphone.

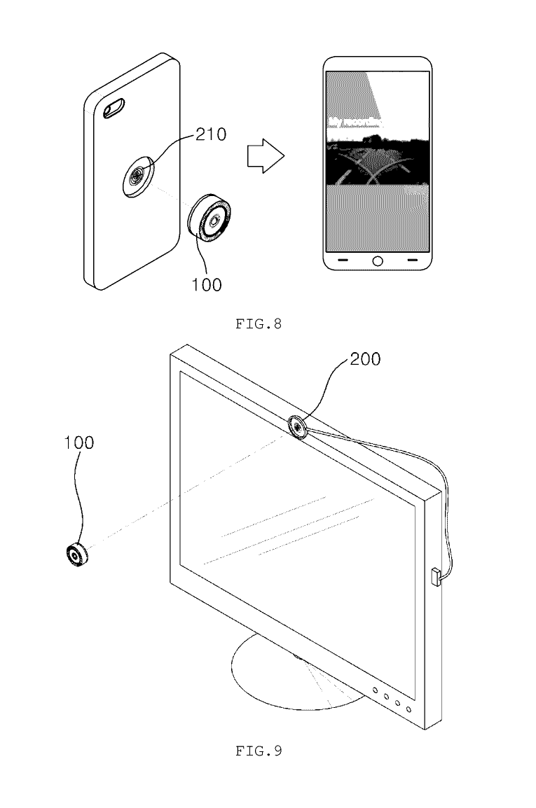

In another embodiment, as shown in FIG. 8, the sub-module 200 that has a pattern electrode 210 and functions as a back cover for a smartphone is coupled to a smartphone 10. The main module 100 is coupled to the pattern electrode 210 of the sub-module 200 so that image information is output to the smartphone 10.

Here, the sub-module 200 having a back cover structure comes into contact with a terminal of the smartphone so that image information of the main module 100 can be output to the smartphone through the pin terminal unit 120 of the main module 100, which contacts the pattern electrode 210 formed on the sub-module 200.

As shown in FIG. 9, a method of coupling the image input device to a TV, which is one of the display means 10, includes connecting the sub-module 200 to the TV using a cable C, and connecting the sub-module 200 to the main module 100 so that image information can be output to the TV.

Recently produced TVs generally have a USB cable terminal. Therefore, the sub-module 200 can be easily connected to such a TV by a USB cable C so that image information can be output to the TV.

The mounting part 260 is provided on a perimeter of the sub-module 200 and is configured such that the main module 100 is fitted into the mounting part 260. The diameter of the mounting part 260 is larger than the outer diameter of the main module 100 so as to enable the main module 100 to be seated inside the mounting part 260 and thus prevent the main module 100 from being undesirably removed from the mounting part 260.

The installation means 270 is a means for fastening the sub-module 200 at a desired position, and is able to have a variety of shapes.

The installation means 270 may be configured to extend from a portion of the housing of the sub-module 200. Alternatively, the installation means 270 may be configured to be removably coupled to the sub-module 200.

In an embodiment, as shown in FIG. 1, the installation means 270 includes a U-shaped elastic member which has bolt holes in respective opposite ends thereof. A portion that is desired to be coupled to the sub-module 200 is inserted into a space defined by the U-shaped elastic member. Thereafter, a fastening bolt is inserted into the bolt holes, and then a nut is tightened over the fastening bolt.

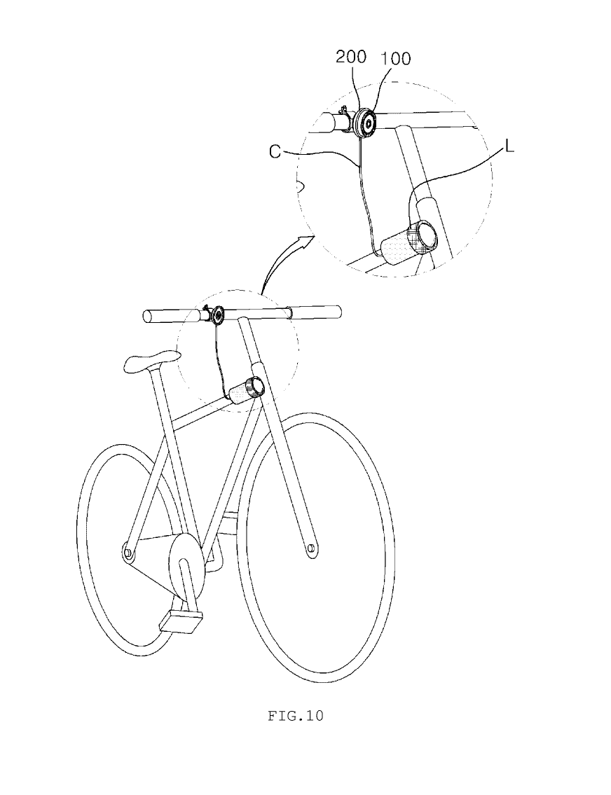

The installation means 270 shown in FIG. 1 can be used to mount the sub-module 200 to a bicycle, as shown in FIG. 10. When the sub-module 200 is mounted to the bicycle, the sub-module 200 may be connected to a light L of the bicycle by a cable C.

When the sub-module 200 is connected to the light L of the bicycle by the cable C, the sub-module 200 can be charged by a power generator or battery of the bicycle.

In this embodiment, although the bicycle has been illustrated as being an apparatus to which the sub-module 200 is mounted, the apparatus is not limited to a bicycle. In other words, the sub-module 200 can be applied to a variety of transportation means.

Generally, bicycles are stored outside rather than inside. Therefore, when the bicycle is not in use, it can be beneficial for the user to be able to remove the image input device from the bicycle so as to protect the image input device from the external environment.

However, in the case of a typical black box that is attached to bicycles, attaching the black box to a bicycle or removing it therefrom inconveniences the user. However, the image input device according to the present disclosure can facilitate the attaching and removal process because the user has only to remove the main module 100 from the bicycle, and may leave the sub-module 200 on the bicycle.

Hence, the image input device can be prevented from being stolen. Furthermore, the sub-module 200 is waterproof and dustproof because it uses a pattern electrode, and thus has no holes or openings. Therefore, the sub-module 200 can be unharmed even when it is used outdoors.

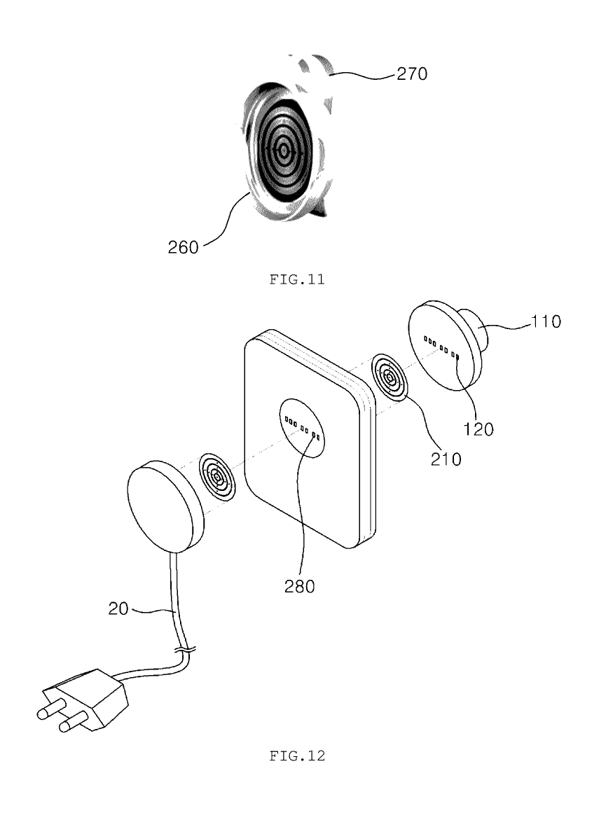

As shown in FIG. 11, the installation means 270 may be configured to be removably coupled to the sub-module 200 and hooked at a desired position in a manner similar to a clip. The installation means 270 can be easily removably coupled to the sub-module 200 such that, as needed, the installation means 270 can be selectively used.

As shown in FIG. 12, a pin terminal unit 280 may be further provided on a surface of the sub-module 200 other than the surface on which the pattern electrode 210 is formed. In this ways, if the pin terminal unit 280 is further provided on the sub-module 200, the sub-module 200 can be connected to the power supply means 20, which is an auxiliary device, so that the sub-module 200 or the main module 100 can be electrically charged simultaneously with the operation of the camera unit 100 of the main module 100.

As such, when the pin terminal unit 280 is provided on the sub-module 200, the power supply means 20 corresponding to the sub-module 200 preferably also includes a pin terminal unit or a pattern electrode. However, this is only an example of the power supply means 20. If the power supply means 20 includes a cable terminal, without having a pin terminal unit or a pattern electrode, charging can be conducted through the connector 250 of the sub-module 200.

As described above, an image input device, such as a subminiature image input device, having a double coupling structure according to the present disclosure can be used in a variety of ways, and the configuration thereof can be changed depending on the field of use.

The image input device , as disclosed herein, is easily portable and rechargeable and can be easily mounted at any position so as to record desired images.

For example, the image input device may be mounted to a transportation means such as a bicycle to function as a black box.

Furthermore, in various embodiments, a main module has a basic camera function, and a sub-module has other extended functions. Thus, the size of the main module can be reduced.

The sub-module is waterproof and dustproof because it uses a pattern electrode, and thus has no holes or openings. Therefore, some embodiments of the present disclosure are appropriate for use with bicycles, which are mainly used outdoors.

In addition, a single main module can be conveniently used, changing only the sub-module depending on the purpose of use.

The configuration and operation of the image input device according to the embodiments are not limited to those of the above-mentioned embodiments. The embodiments can be modified in various ways by selectively combining all or some of the embodiments with each other.

Although various embodiments have been disclosed for illustrative purposes, those skilled in the art will appreciate that various modifications, additions and substitutions are possible, without departing from the scope and spirit of the invention as disclosed in the accompanying claims.

What is claimed is:

1. An image input device, comprising:
a main module comprising a camera unit configured to capture an image, and a pin terminal unit configured to generate a first operation signal to start controlling the camera unit upon contacting a pattern electrode; and
a sub-module comprising the pattern electrode configured contact the pin terminal unit to cause generation of the first operation signal,
wherein the main module and the sub-module are configured to be removably physically coupled to each other, and wherein the first operation signal and a power signal to activate the camera unit are generated when the main module and the sub-module make electrical contact that is caused at least in part by a physical coupling between the main module and the sub-module.

2. The image input device of claim 1, wherein the main module further comprises a first processing unit configured to control power of the camera unit upon receiving the first operation signal and to control image information obtained by the camera unit.

3. The image input device of claim 1, wherein the pin terminal unit includes at least one of a charging terminal, a data communication terminal and a signal terminal.

4. The image input device of claim 2,
wherein the main module further comprises a coupling detection unit configured to generate a second operation signal to start controlling the camera unit from an outside upon contacting a detection means, and the sub-module further comprises the detection means configured to cause generation of the second signal upon being coupled to the coupling detection unit, and
wherein the first processing unit is configured to control the camera unit after receiving at least one of the first operation signal and the second operation signal.

5. The image input device of claim 4, wherein the first processing unit is configured to control the camera unit after receiving both the first operation signal and the second operation signal.

6. The image input device of claim 5, wherein the first processing unit comprises:
a memory unit configured to store image information obtained by the camera unit;
a charging unit configured to be charged through the pin terminal unit; and
a control unit configured to control the camera unit after receiving at least one of the first operation signal and the second operation signal.

7. The image input device of claim 1, wherein the main module and the sub-module further comprise respective magnets generating magnetic force, the magnets being disposed such that opposite poles face each other.

8. The image input device of claim 4, wherein the coupling detection unit comprises one of a contact signal terminal, a magnetic sensor, a proximity sensor, and a radio recognition sensor.

9. The image input device of claim 1, wherein the pattern electrode is configured to have a conductive plate shape corresponding to a pin terminal that can generate the first operation signal.

10. The image input device of claim 1, wherein the pattern electrode is patterned to have a concentric circle shape, or is patterned to have a pin shape at a position corresponding to the pin terminal unit.

11. The image input device of claim 1, wherein the sub-module further comprises
a second processing unit, including at least one of a location tracking unit configured to receive location information, a memory unit configured to store the location information and backup data of the main module, a wired-wireless communication means for communicating with an external communication means in a wired or wireless manner and a charging unit configured to provide power to the main module.

12. The image input device of claim 1, wherein the sub-module further comprises a mounting part to which the main module is mounted such that the main module is prevented from being removed from the sub-module.

13. The image input device of claim 1, wherein the sub-module further comprises an installation means for fastening the sub-module at a desired position.

14. The image input device of claim 1, wherein the sub-module further comprises a connector configured to be connected to an external auxiliary device for extension of functionality.

15. The image input device of claim 1, wherein the sub-module is configured such that a pin terminal unit is formed on a surface of the sub-module other than a surface thereof on which the pattern electrode is formed.

16. The image input device of claim 14, wherein when the main module is coupled to the sub-module and connected, by the connector of the sub-module, to a display means, which is the auxiliary device, image information of the main module is output to the display means.

17. The image input device of claim 16, wherein the display means comprises any one selected from among a smartphone, a computer, and an imaging device.
